(19) United States
(12) Patent Application Publication
(10) Pub. No.: US 2005/0033761 A1
(43) Pub. Date: Feb. 10, 2005

(54) System and method for generating and using a pooled knowledge base

(76) Inventors: William Guttman, Pittsburgh, PA (US); Jonathan Rosenoer, Tiburon, CA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/793,110

(22) Filed: Mar. 4, 2004

Related U.S. Application Data
(60) Provisional application No. 60/451,849, filed on Mar. 4, 2003.

(51) Int. Cl. G06F 17/00

(52) U.S. Cl. 707/102

(57) ABSTRACT

A method of dynamically creating a database is comprised of receiving event data from a plurality of independent agents input according to a common taxonomy that exposes the event in its molecular terms, e.g., causal factors driving the event and mitigating factors related to the event, and storing the event data. The molecular terms may be weighted. Additionally, the agents inputting the event data may be authenticated to insure that data is being entered by only those parties authorized to do so. The event data may also be validated by reference to external sources of information. The event data may additionally be normalized, anonymized and scaled. Synthetic event data may be added to the database for those situations where actual data is not available or is not very comprehensive. The synthetic event data may be generated by one of a test bed or a subject matter expert. After the database is created, a search engine or analytic engine may operate on the data to provide various reports such as root cause, failure, what-if, among others. Because of the rules governing abstracts, this abstract should not be used in construing the claims.

### CROSS-REFERENCE TO RELATED APPLICATIONS

This application claims the benefit of provisional application no. 60/451,849 filed Mar. 4, 2003 and entitled Operational Risk Engine, the entirety of which is hereby incorporated by reference.

### BACKGROUND OF THE INVENTION

The present disclosure is directed generally to a method and apparatus for dynamically generating a superset of event data from independent entities and operating on that data for various purposes such as reducing risk, optimizing a process, allocating resources, predicting failures, automatically implementing changes (such as updating filters, modifying computer code, etc.), providing a diagnosis, and the like.

Merely gathering quantitative data does not provide for effective decision making, whether the decision to be made involves the minimization of risk, the optimization of a process or procedure, the allocation of resources, or predicating failures. For example, in the banking arena, FIG. 1 illustrates QIS-3 quantitative data generated by 89 banks in 19 different countries reporting 47,000 events representing a $7.8 billion gross loss. While this represents an impressive amount of data, it is data reported by banks of different sizes, operating in different regulatory environments, conducting different kinds of transactions according to different local customs, etc. such that there is no clear way to use the data in an effective manner to predict losses for a particular bank, reduce risk for a particular bank, etc.

What is typically missing from databases, which are often a mere collection of historical data, are the elements that make up the events of interest. In the context of, for example, an equipment failure, the failure may be recorded but not the root cause or the events leading up to the failure. Also typically lacking are the identification of other factors related to an event such as controls that, had they been in place and enforced, might have prevented the event from occurring and mitigating factors that caused the event or its impact to be less severe than might otherwise have been the case. Without such detailed information about the events, it is difficult to make meaningful decisions or take the most appropriate action.

### BRIEF SUMMARY OF THE INVENTION

The present disclosure is directed to a method of dynamically creating a database comprising receiving event data from a plurality of independent agents, input according to a common taxonomy that exposes the event in its molecular terms, e.g., causal factors driving the event and mitigating factors related to the event. The event data is stored. The molecular terms may be weighted. Additionally, the agents inputting the event data may be authenticated to ensure that data is being entered by only those parties authorized to do so. The event data may also be validated by reference to external sources of information. The event data may additionally be normalized, anonymized and scaled. Synthetic event data may be added to the database for those situations where actual data is not available or is not very comprehensive. The synthetic event data may be generated by one of a test bed or a subject matter expert. After the database is created, a search engine or analytic engine may operate on the data to provide various reports such as root cause, failure, what-if, among others.

In one application, the database may be comprised of software failure events experienced by users of a particular software program and the impact, mitigants, controls and causes related to the events. In other applications, the database may be comprised of events dealing with the operation of an assembly line, events dealing with equipment failure within a larger system (e.g. an airplane) or medical events. The database may contain the impact, mitigants, controls and causes related to each event. An apparatus working on the database can produce a number of reports including a risk of failure report, optimization report, resource allocation report, failure prediction report, root cause report, and “what if” report, among others.

In another application, the database may be comprised of loss realization events experienced by financial institutions and the financial impact, mitigants, controls and causes related to the events. An apparatus working on the database can make determinations of the amount of capital that must be set aside to conform with, for example, the Basel II requirements.

### BRIEF DESCRIPTION OF THE DRAWINGS

For the present invention to be easily understood and readily practiced, the present invention will now be described, for purposes of illustration and not limitation, in conjunction with the following figures, wherein:

FIG. 1 illustrates certain Quantitative Impact Study (QIS-3) data for 2001, as published by the Bank for International Settlement (www.bis.org/bcbs/qis/qis3.htm);

FIG. 2 illustrates how the pooled knowledge base of the present invention may be created and used;

FIG. 3 illustrates a conceptual framework of how to identify threats and risks in a particular context;

FIGS. 4A through 4C illustrate the molecular decomposition of events into causal drivers, controls and mitigating factors;

FIG. 5 illustrates building a superset molecular database for operational risk;

FIG. 6 illustrates an example of a superset molecular model of operation risk;

FIG. 7 is a simplified diagram illustrating a system for implementing the method of the present disclosure;

FIGS. 8A through 8F illustrate a template driven input process which constrains event data input according to a predefined taxonomy;

FIG. 9 illustrates the use of sub-systems to drive specialized functions while building core system richness; and

FIG. 10 is an example of extended functionality achieved by the system shown in FIG. 7.

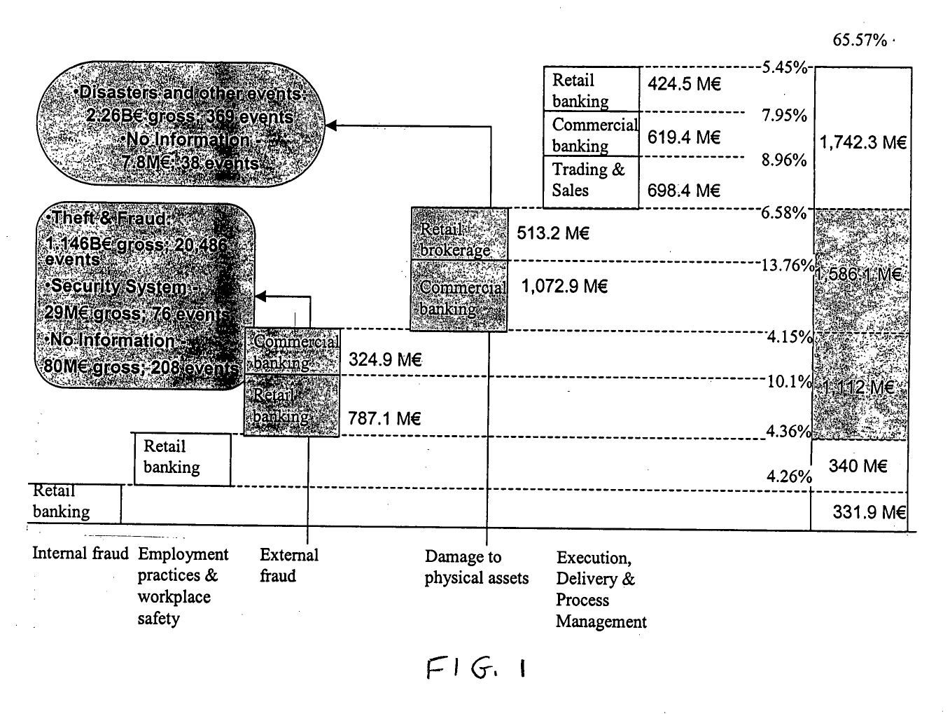

### DETAILED DESCRIPTION OF THE INVENTION

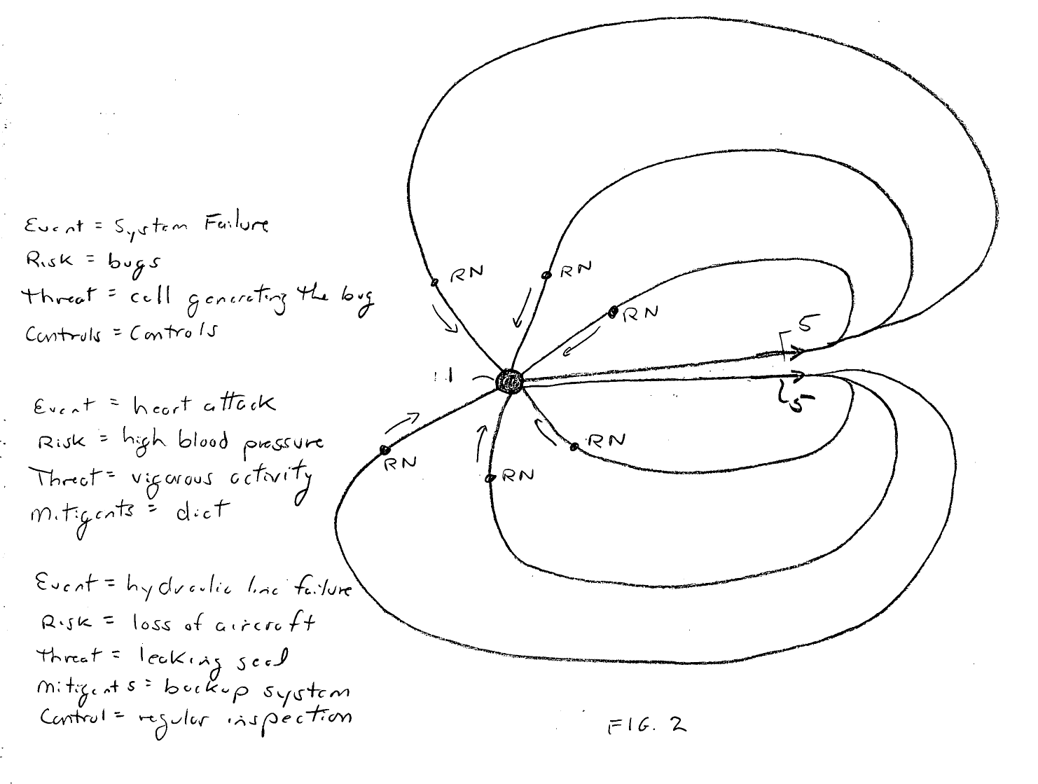

FIG. 2 illustrates how a pooled knowledge base 1 may be constructed and used according to the present invention. The pooled knowledge base 1 may be comprised of events which are recorded by reporting nodes RN that would typically be independent of one another and be considered to be outside contributors to the knowledge base 1. Events are reported according to a common taxonomy that exposes the molecular terms related to the event. For example, in the context of a software bug reporting system, the RNs may report to the knowledge base 1 events such as system failures in terms of the risk (bug that caused the system failure), the threat or causal factors (e.g. a system call that caused the bug) and any known controls that could have eliminated the bug and ultimately, the system failure. This data may be processed by a reporting engine (not shown in FIG. 2), which may then issue an alert 5 to the RNs identifying the control that needs to be implemented to prevent the reported bug from causing a system failure. In an automated system, the alert could be in the form of a program that is sent to the RNs to automatically search the RN's code for the offending system call, and automatically implement a code change to prevent the bug.

In another application the RNs could be physicians inputting information about medical events, e.g. heart attacks, together with the event's molecular terms, e.g., risk factors, threat factors, mitigants and controls. In another application the RNs could be airplane manufacturers inputting events related to equipment failures in a particular aircraft, together with the event's molecular terms, e.g., risk factors, threat factors, mitigants and controls for the events. In such applications, a reporting engine can operate on the data to extract meaningful information, e.g. patient A is in immediate risk of a heart attack unless controls are implemented, airplane model X should be grounded until certain maintenance can be performed, etc. In yet another application the events may be opportunities, e.g. opportunities for financial gain. By constructing a pooled knowledge base 1 of events that might cause a company's stock to go up, or down, analysis of the knowledge base could yield buy/sell information that could be automatically or manually implemented. Thus, one aspect of the present invention is a method of constructing a new kind of pooled knowledge base that is a powerful tool for identifying trends, links between events and the like that otherwise would go undetected.

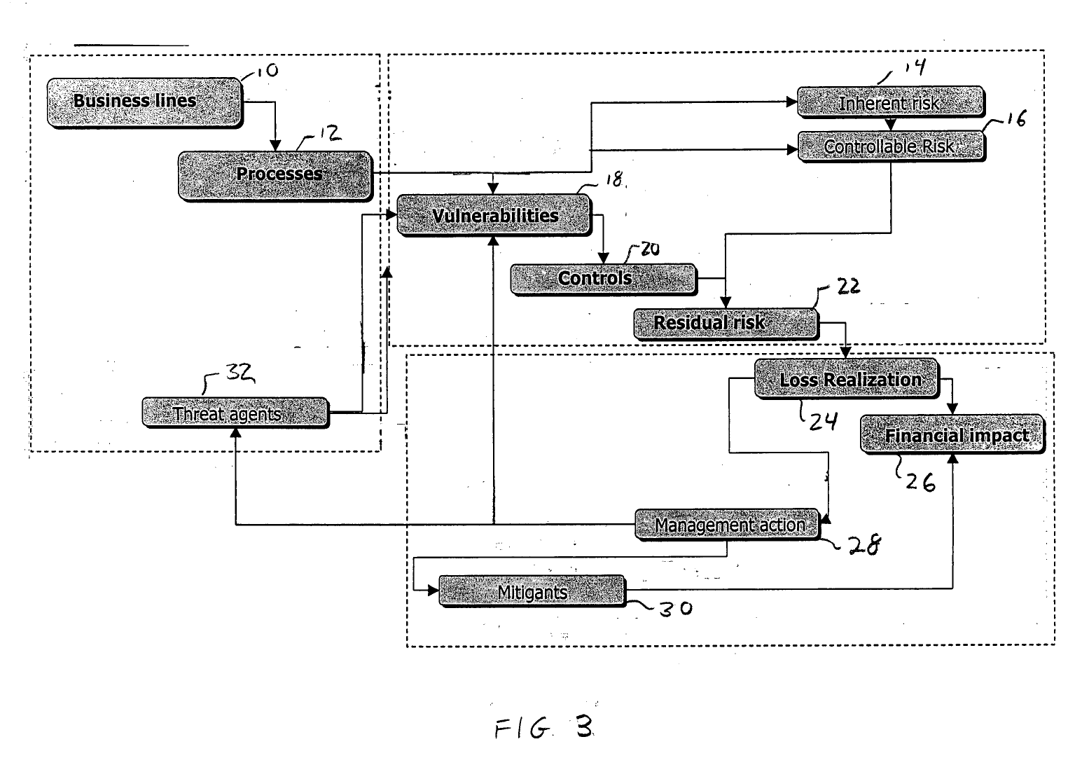

FIG. 3 illustrates a conceptual framework of how to identify threats and risks in a particular context. This framework serves as a basis for identifying vulnerabilities and identifying the molecular elements of a loss event and their interrelationships. In the example shown in FIG. 3, which is intended to be exemplary and not limiting, business lines 10 are made up of a plurality of processes 12. Those processes contain both inherent risk 14 and controllable risk 16. The processes 12 are also subject to vulnerabilities 18 that may be caused by threat agents 32, that may be realized as failure events. These events may take place if not eliminated by controls 20. When controls 20 are in place, the inherent risk 14 and controllable risk 16 may be reduced to a residual risk 22 that is subject to a loss realization 24 producing a financial impact 26. The loss realization 24 requires management action 28 to trigger mitigants 30 that minimize the financial impact 26. Management action 28 may also identify specific threat agents 32 that exploited a vulnerability in a particular case. When viewed in this manner, the vulnerabilities, or events, can be broken down into their causal factors (threat agents 32) mitigating factors (mitigants 30) as well as controls 20.

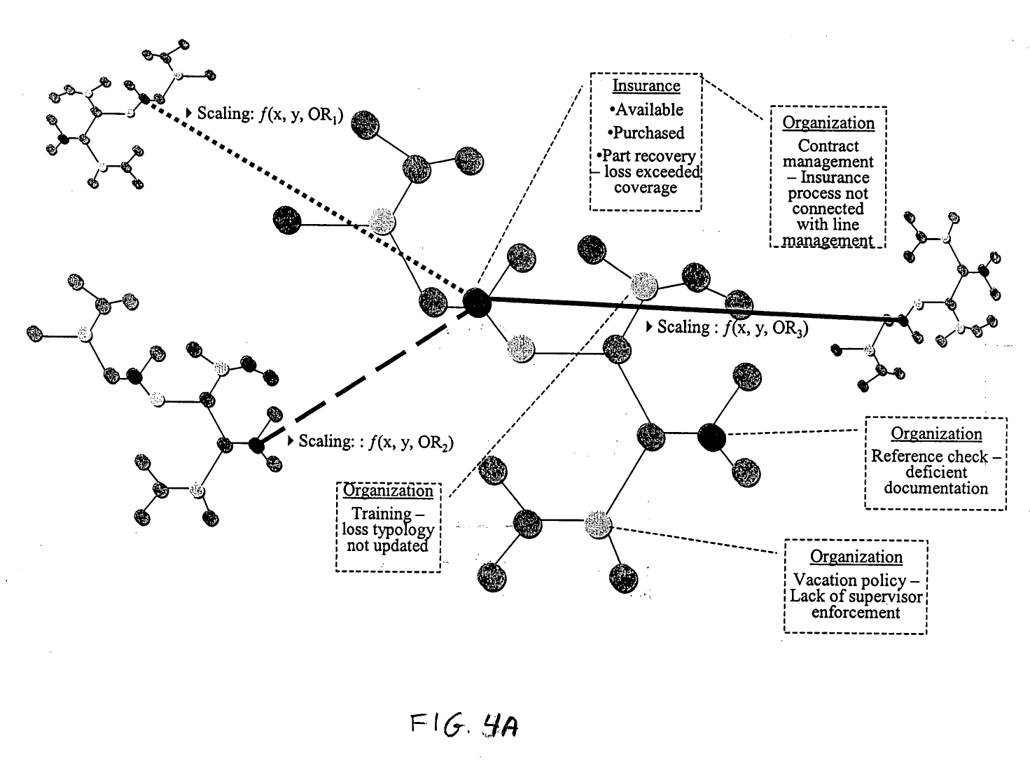

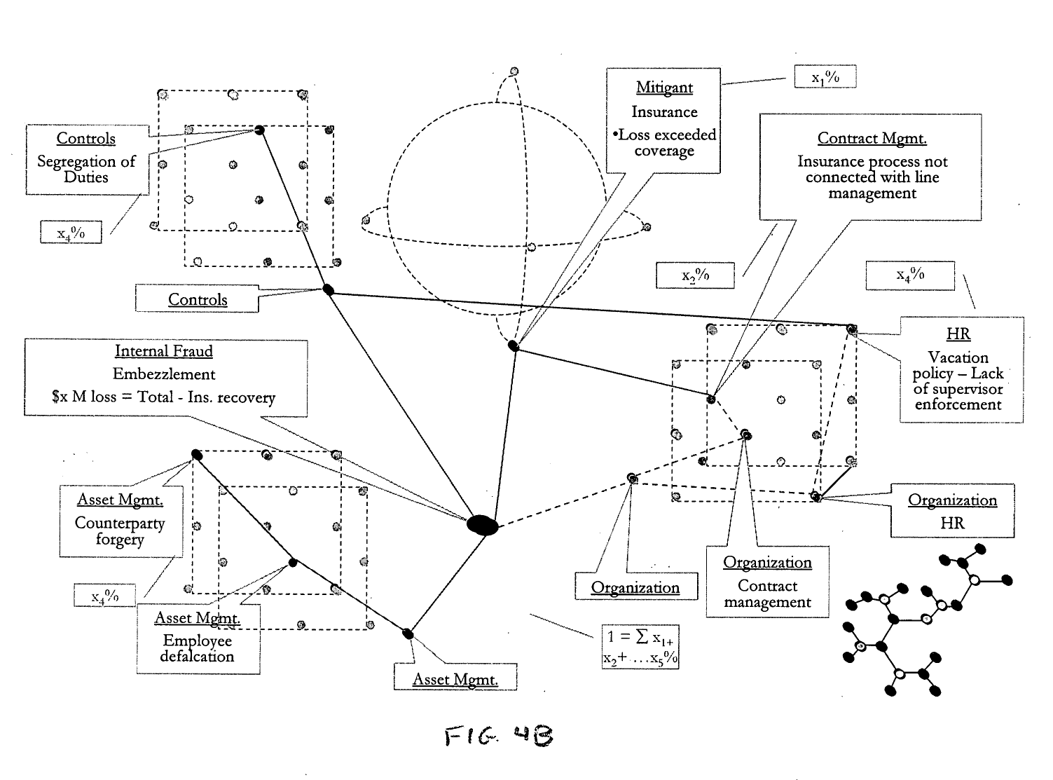

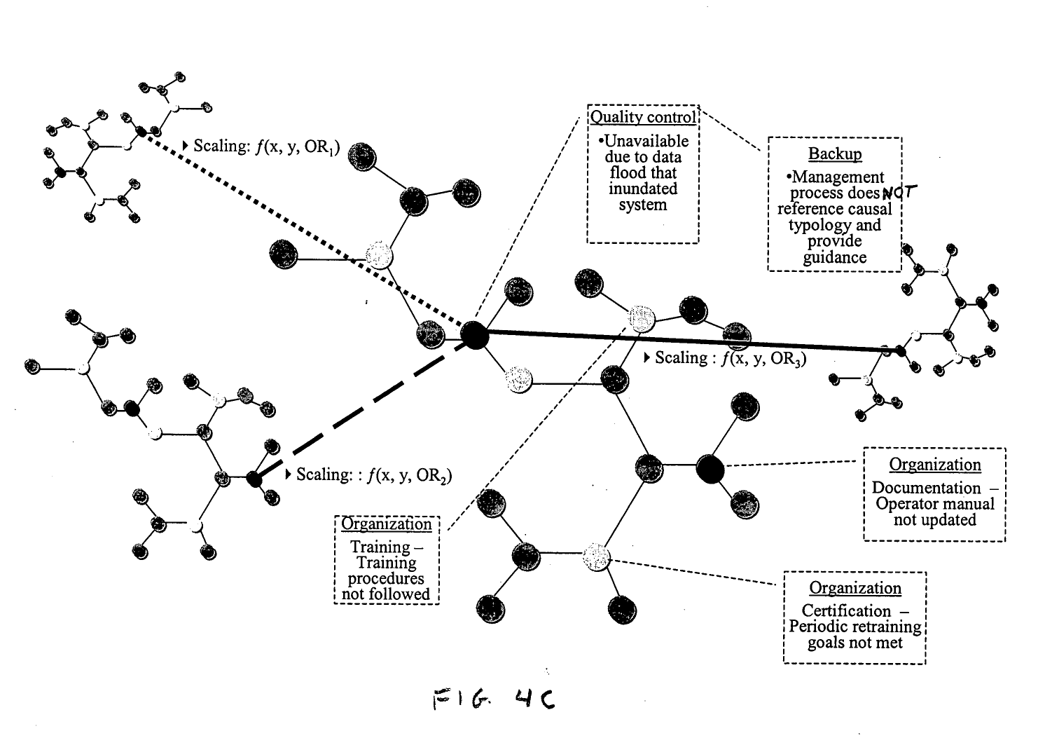

FIGS. 4A and 4B illustrate the decomposition of an identified loss event into factors from which the loss emanated (causal factors) and those control factors which, had they been in place, could have prevented the loss. In the illustrated example, the loss event was covered by insurance, which was both available and purchased. However, there was only a partial recovery because the loss exceeded the coverage. The obligation to purchase insurance, according to the institution's organization, was the responsibility of contract management. However, those responsible for the insurance process were not in communication with line management. Therefore, the insurance coverage was either purchased in the incorrect amount or not updated as a result of a change implemented by line management.

FIG. 4A additionally shows how different data containing different sets of causal and mitigating factors can be mapped to a common framework, model, and language so that appropriate management decisions can be implemented. A pooled knowledge base or aggregate database is a super set of data that transcends an individual organization and allows for mapping between one organization's factors and another's. The mapping is achieved by determining what scaling function needs to be applied to each factor to make each factor comparable to one another. For example, if operational risk is to be considered within a single, homogenous organization, the data need not be scaled. Rather, the data need only be normalized, e.g. consistent use of terminology, measurement techniques, units of measure, etc. If, however, a trans-organizational database is to be generated, there is a need to provide a method of interchanging the loss data from one organization to another. To do so requires scaling of the normalized data. The pooled knowledge base may utilize a rating system in which each institution or independent agent supplying event data is certified according to categories based on defined criteria so that normalized event data from that institution can be quantitatively scaled to other institutions.

FIG. 4C illustrates a situation where an event is based on the failure of a quality control subsystem within an assembly line. In this case, the automated quality control subsystem was knocked offline and became unavailable due to a computer virus that disabled the functioning of the system. Management was unable to respond as it did not recognize the interrelationship between a virus attack experienced by the firm in general, and the fact that the quality control subsystem could be made inoperable if the processors that run the system were occupied with the task of retransmitting viruses instead of running the quality control subsystem. A secondary cause of the problem was that proper management training could have led to early recognition of the problem and its solution, but training/recertification procedures were not followed. In an automated system, corrective action, such as passing control over to backup systems, could be automatically implemented.

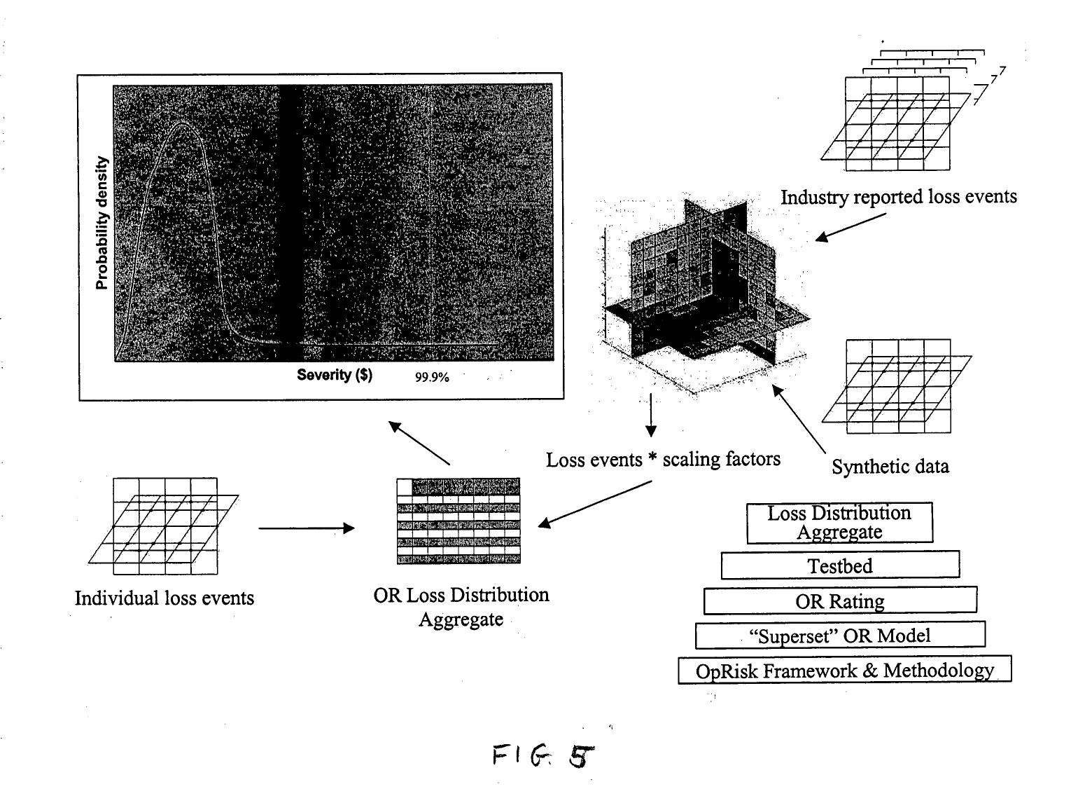

FIG. 5 further clarifies how the data being input from various sources may be used to dynamically create a pooled knowledge base. Event data coming from industry reported loss events must be scaled where the events are be reported by organizations from different categories. As seen in FIG. 5, one input to the pooled knowledge base is industry reported loss events. Another input may be individual loss events. In certain cases, such as where new technology or processes are being put into operation, there may be no available reported loss experience. In such cases, synthetic data may be used to supplement or complete the database. Synthetic data can be calculated data for example by use of a test bed, or provided by a subject matter expert. The various event data, after being aggregated, may be illustrated through a loss distribution chart or graph.

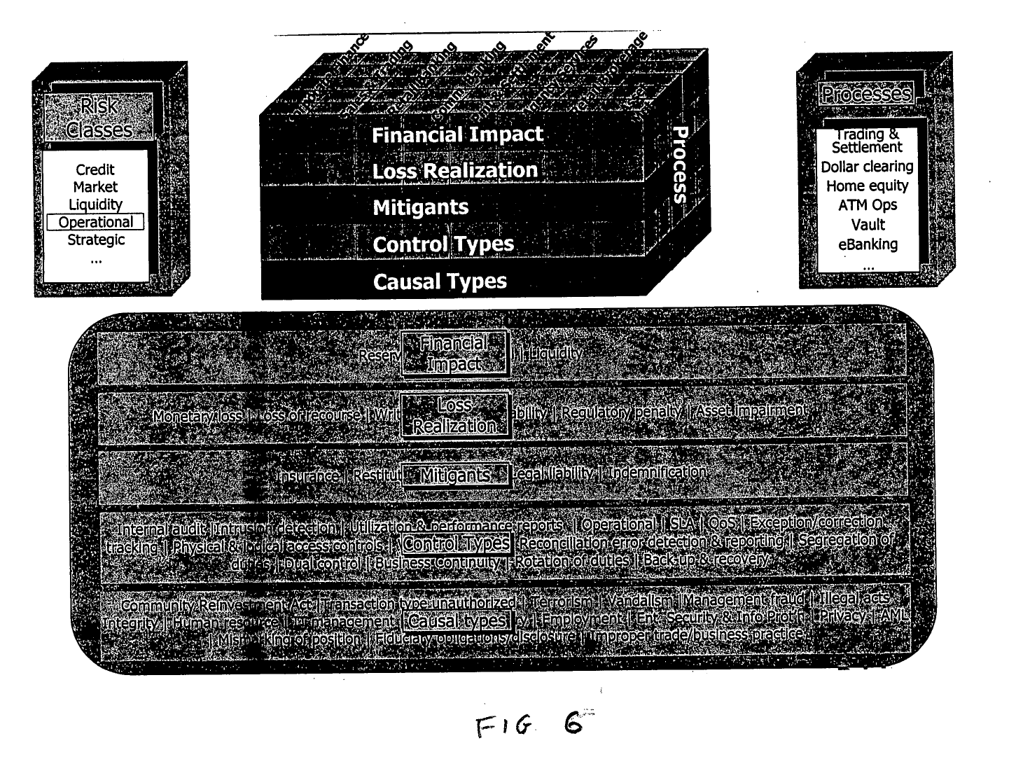

FIG. 6 is a graphical representation of an example of a superset molecular taxonomy of operational risk. The horizontal rows in the model represent, from bottom to top, causal types, control types, mitigants, loss realization and financial impact while vertical slices through the model represent, from left to right, corporate finance, sales and trading, retail banking, commercial banking, payment and settlement, agency services, retail brokerage, and asset management. The molecular taxonomy, when instantiated in a model and populated with event data comprising mitigants, controls, causes, etc. provides for a pooled knowledge base which may be used in a variety of ways as described herein.

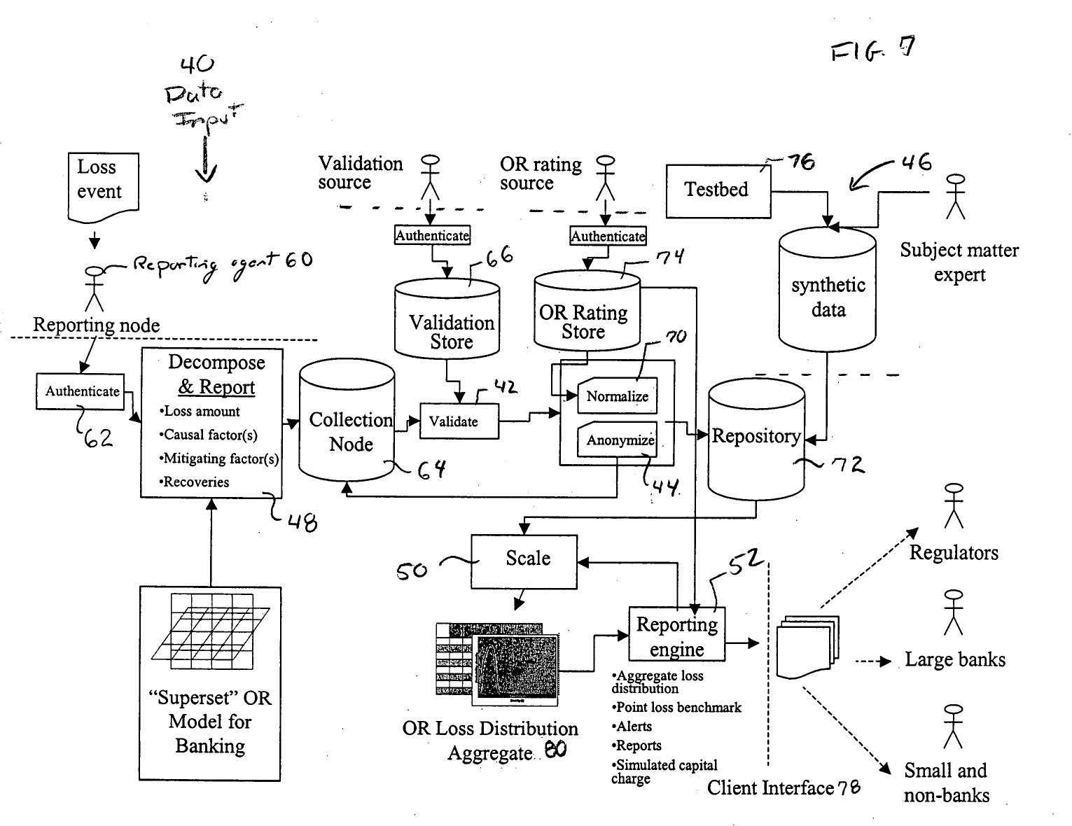

FIG. 7 illustrates one embodiment of a computer implemented method and system constructing according to the present disclosure. The example shown in FIG. 7 is for assessing operational risk (OR), defined as the risk resulting from inadequate or failed internal processes, people, and systems or from external events (including legal risk, but, in this example, excluding strategic, reputational and systemic risk), although the method and system can be applied more broadly as discussed above to making decisions or taking corrective action based on the reported events. The method includes at 40 receiving loss data pertaining to a plurality of business activities and transactions for a plurality of institutions, whether operating in a vertical industry or industry sub-segment or operating horizontally across industries and industry sub-segments. The loss data may include at least one of a loss type and at least one of a causal factor, a loss amount in each instance and at least one of a mitigating factor, if present, that reduced the direct loss. The method and system further include the ability for reported loss data to be validated by a third party through a validation process 42 and then anonymized at 44. The method and system further include the ability to generate and introduce synthetic loss data at 46, such as where loss data is unavailable in the historical record. The method and system further include at 48 the means to assess absolute and relative levels of operational risk by decomposing and quantifying the risk factors in the model so that the risk factors can be used to determine areas in a given financial institution's operations where risk mitigation is lacking or insufficient and to determine which mitigating factors are critical relative to others. The method and system further refine the assessment of operational risk by building a scaling algorithm at 50 that takes into account each causal factor for a given loss, its relative weight with respect to other causal factors, and the degree to which it is mitigated at a given institution. A reporting engine 52 can balance the causal, the mitigating, and the scaling factors related to the loss, adjust the loss for importance in the institution's overall activity and then make a quantitative comparison to a plurality of other financial institutions such that an institution can determine an appropriate capital allocation accounting for such risk or a prospective capital allocation can be determined in the model. The reporting engine 52 may also perform a root cause analysis, a what-if analysis or a forecast, among others.

The data input function 40 may be performed by a reporting agent 60 at a reporting node (RN), with RN's being located at each of the various independent organizations that may be reporting entities, or at each of the various independent departments, companies, divisions, etc. within a single organization. In this implementation, we assume the entity is a bank. RN is authorized to provide a loss event report to the system. A reporting agent is authenticated as an RN through an authentication process 62. RN reports the loss event by reference to the “superset” OR Model for Banking, shown in FIG. 6 and derived from a foundational operational risk framework and methodology. The model provides a means for RN to anchor and identify the loss event to the model and decompose the loss in terms of elemental causal and mitigating factors described in the model. The model is capable of being a superset of all models, as opposed to being a replacement model.

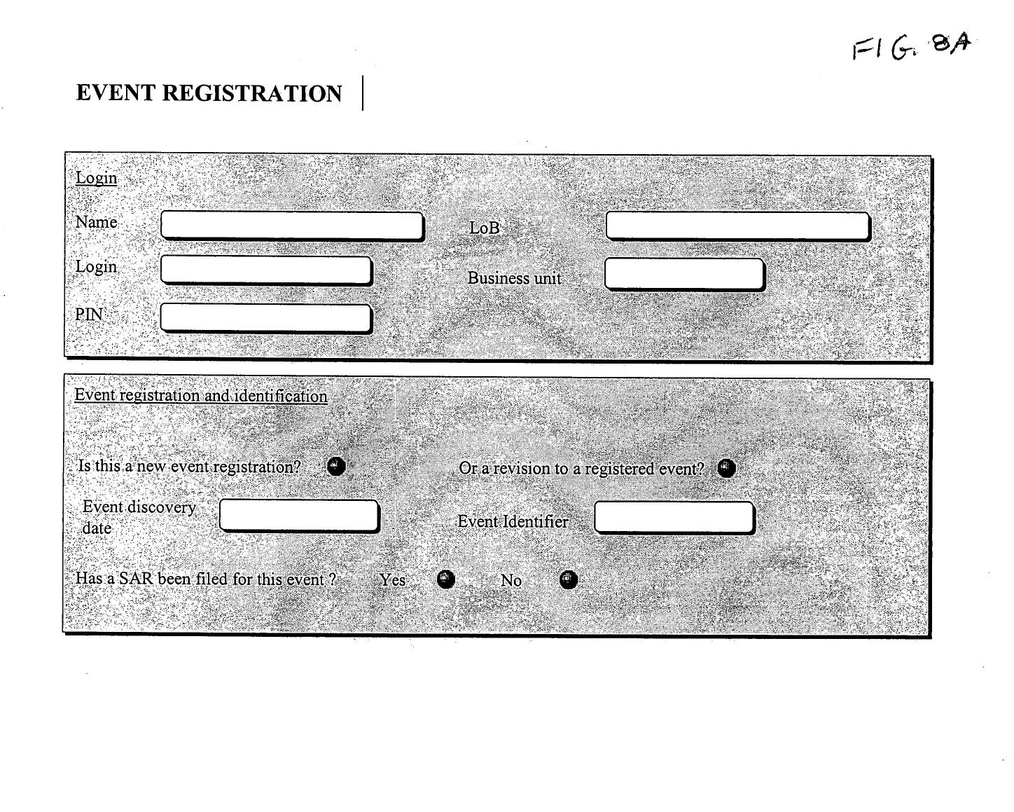

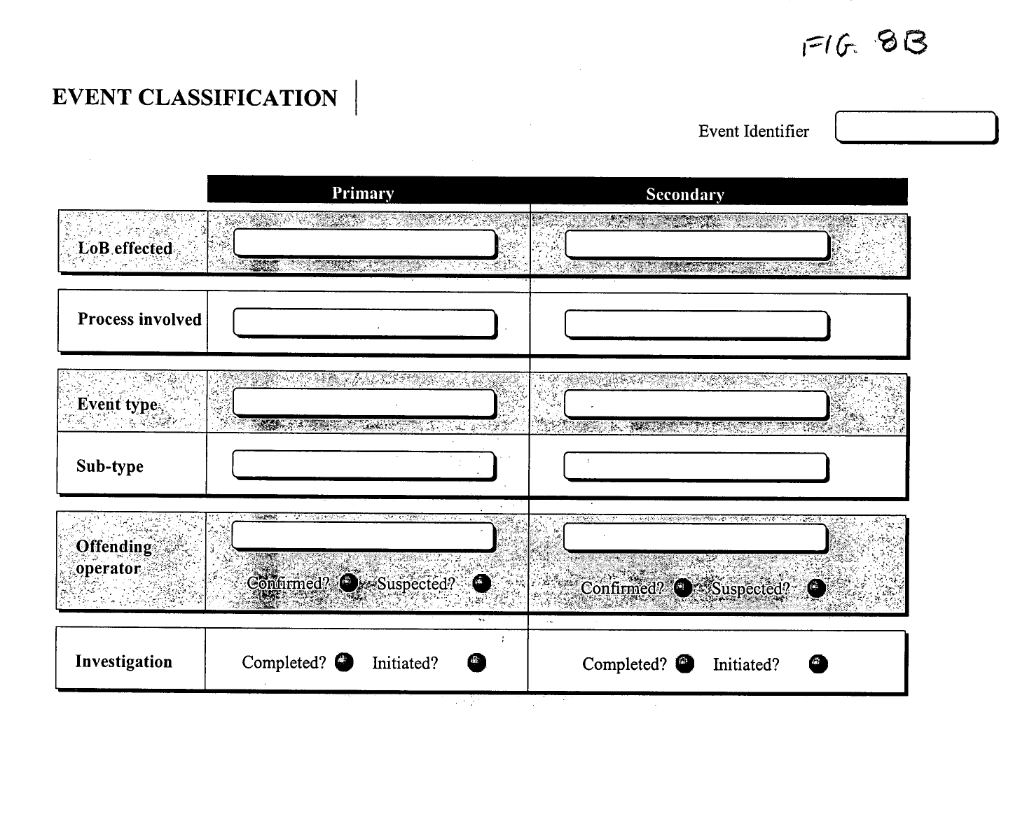

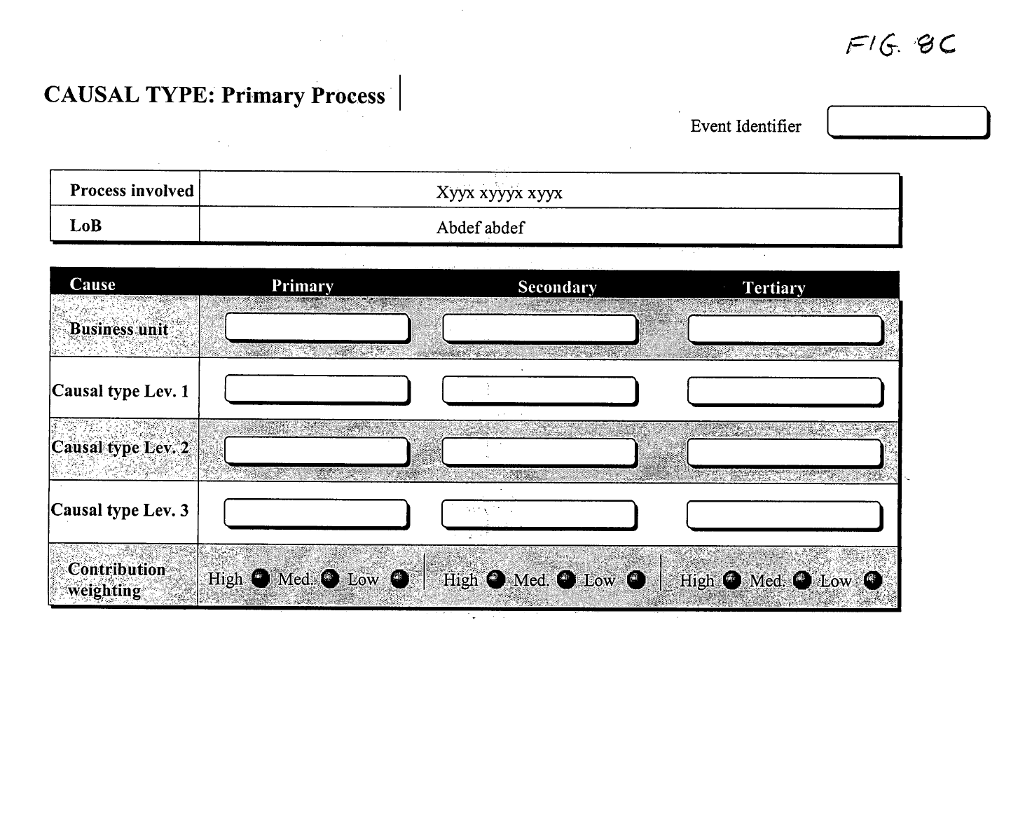

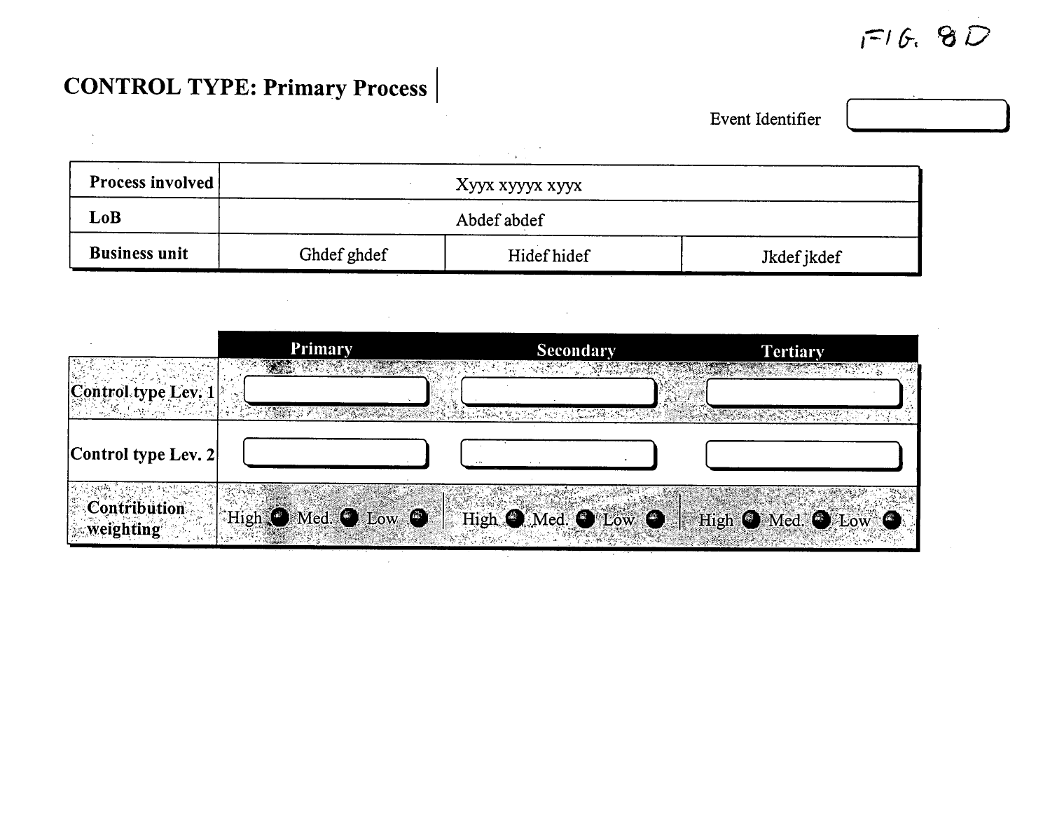

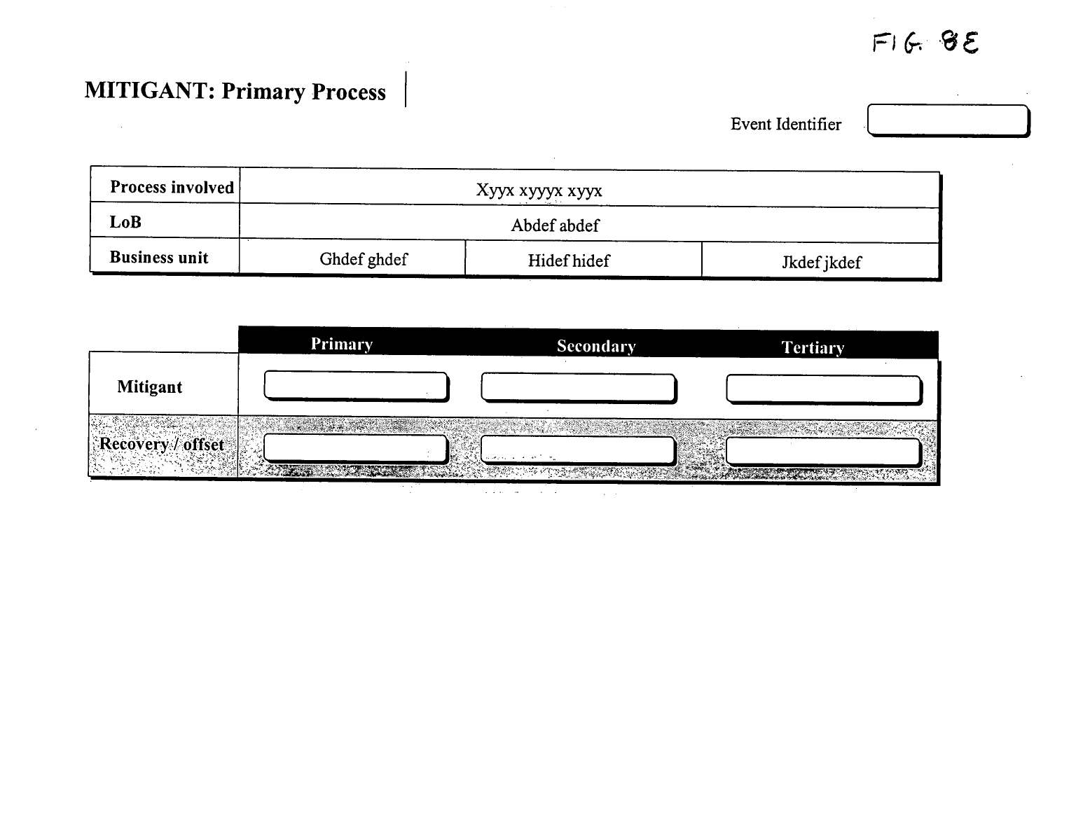

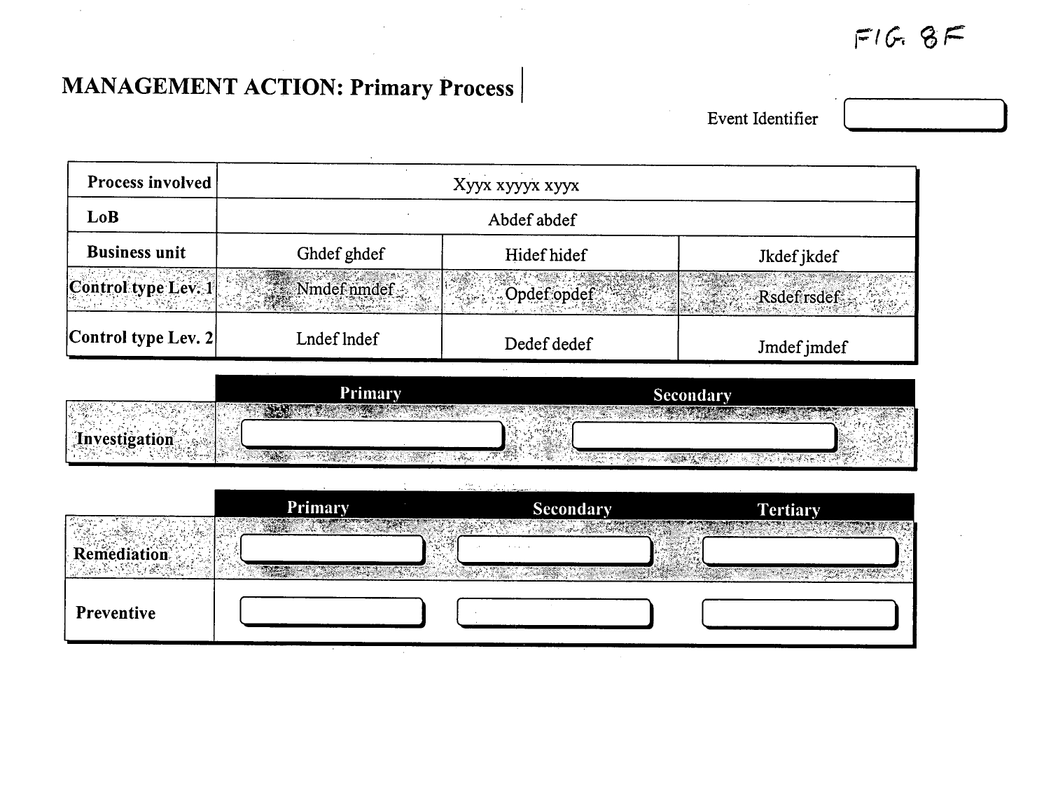

In a particular instance, RN may interact via the Internet or any other appropriate connection with the model in the form of a directed algorithm that requests RN to answer a range of questions to capture the decomposition and quantitative observations relating to the loss at issue (e.g., assignment of weights to causal and mitigating factors relating to each of their contributions to the reported loss), as shown in FIGS. 8A-8F. The taxonomy need not be constrained or static. That is, RNs could be free to add new events and new molecular terms as needed. Alternatively, the event data could be entered at a higher conceptual level with an appropriate engine doing the decomposing.

RN sends this information to a collection node 64. Note that it is not important to the present invention where the decompose and report function resides, whether on RN or on the collection node 64. As mentioned, the reporting agent 60 and/or RN can be authenticated at 62 to provide assurance that RN is in fact authorized to input data to the system.

The loss event reported by RN may be validated against a validation store 66 populated by an authenticated, external, validation source. For example, the validation store might receive copies of Suspicious Activity Reports (SARs) prepared by RN's parent entity for the government, or copies of claims submitted to insurance companies. The system would be able to compare an event reported by RN with events reported to or by other sources, such as via a SAR or insurer, and note the presence or absence of a correlation.

Loss event data, which may or may not be validated, is processed through a subsystem that normalizes 70 and anonymizes 44 the data prior to sending it to a data store, titled repository 72 . The normalization subsystem 70 refers to the “superset” OR model shown in FIG. 6 and, using various processes and algorithms, builds a generalized data set from the input event data that fits within the populated superset model, which is housed in the repository 72. The normalization process 70 may be fed in substantial part by one or more ratings derived from observing the scope and scale of RN's parent and state of its technologies, processes and controls. This OR rating may be reported by an authenticated third party source, such as an external auditor, from time to time and held in an OR rating store 74. Other factors may also be utilized by the scaling subsystem 50.

Anonymization 44 is designed to strip from particular reported loss event data information that would directly identify the source of the loss event, e.g., RN or its parent, or private information of persons or other entities involved in the event. Advanced anonymization techniques will be implemented to defeat attempts to reattribute reported loss event data to its source. For example, once a particular event completes its path to the repository 72, then all data related to the reported event is deleted from all preceding systems and processes; associated data records in the collection node 64 are deleted; other data manipulations or access controls may also be performed and or implemented to guard against reattribution. This process and system enable the repository 72 to serve as a pool of anonymized shared loss event data.

Another input to the repository 72 is synthetic data. The purpose of this data is to supplement data derived from observed and reported events with data for losses for which there may be limited experience, that may not have yet been observed, or for which data may not be available for some other reason. For example, a test bed subsystem 76 may be utilized to obtain data on a new technology implementation. Subject matter experts' subjective evaluation may also contribute to development of synthetic data in particular instances.

At a client interface 78, a client (small banks, non-banks, large banks, broker-dealers, regulators, among others) is able to interact with the system via an interface that connects to the reporting engine 52. The reporting engine 52 is able to identify the client, in part by reference to the OR rating store as available as well as by reference to other factors. Note that it is likely that some clients will also be RNs.

A principal interaction of a client with the system in this example will be to review a loss distribution aggregate tuned to the client's particular characteristics by means of the scaling process 50 operating on data contained in the repository 72 and on data obtained from the client. Using this aggregate, a client may be able to analyze and establish its relative position and performance of its operational risk management systems. A client may also be able to use information from the aggregate to correct or supplement data in its own loss distribution model. The reporting engine 52 is capable of a range of other functions which enable the client to engage in a number of useful operations utilizing aggregate data in combination with data provided by the client. These include providing aggregate loss distributions, point loss benchmarks, alerts, reports, simulated capital charges, “what-if” analyses, among others.

The utility of the aggregate loss distribution 80 and associated information reportable by the system extends beyond the set of large banks required to implement operational risk management systems under the Advanced Measurement Approach and to hold regulatory capital against operational risk under Basel II. (Basel II is a proposal by the Basel Committee for International Settlement that recommends, among other things, a new capital charge for operational risk for internationally active banks.) For example, regulators are able to use the system in assessing the loss distribution assumptions and loss management performance of a particular bank against its peer group. Small banks and broker-dealers will also be able to use the system to obtain a better understanding of their performance and manage their operational risk. Insurance companies may also utilize the system in the design of associated risk transfer products. As discussed above, virtually any type of business could construct such a pooled knowledge base and use it in their planning and decision making processes.

Although the example given in FIG. 7 is directed to operational loss in the banking setting, the method and system are extensible. The system and method can be utilized, for example, to create OR Models and loss distribution aggregates for other industries.

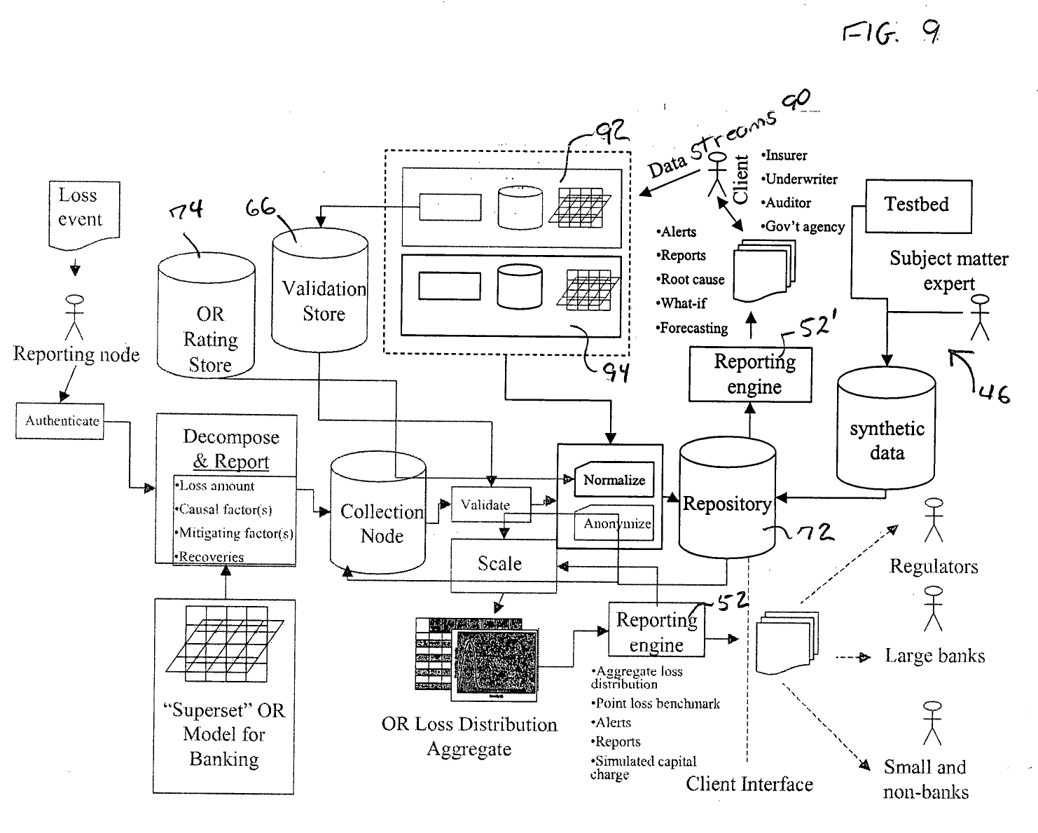

FIG. 9 illustrates one example of how the method and system of FIG. 7 may be extended by introduction of specialized subsystems. In FIG. 9, the system accepts streams of information 90 from channels or sources other than industry member RNs directly reporting loss event data into the system. For example, the system might acquire SAR data reported to the government to be used as validating data as shown in subsystem 92. In certain cases, however, that data might be fed through subsystem 94 to improve the quality and extent of data in the repository 72 . Other sources of data in this example may include insurance companies, underwriters, and auditors.

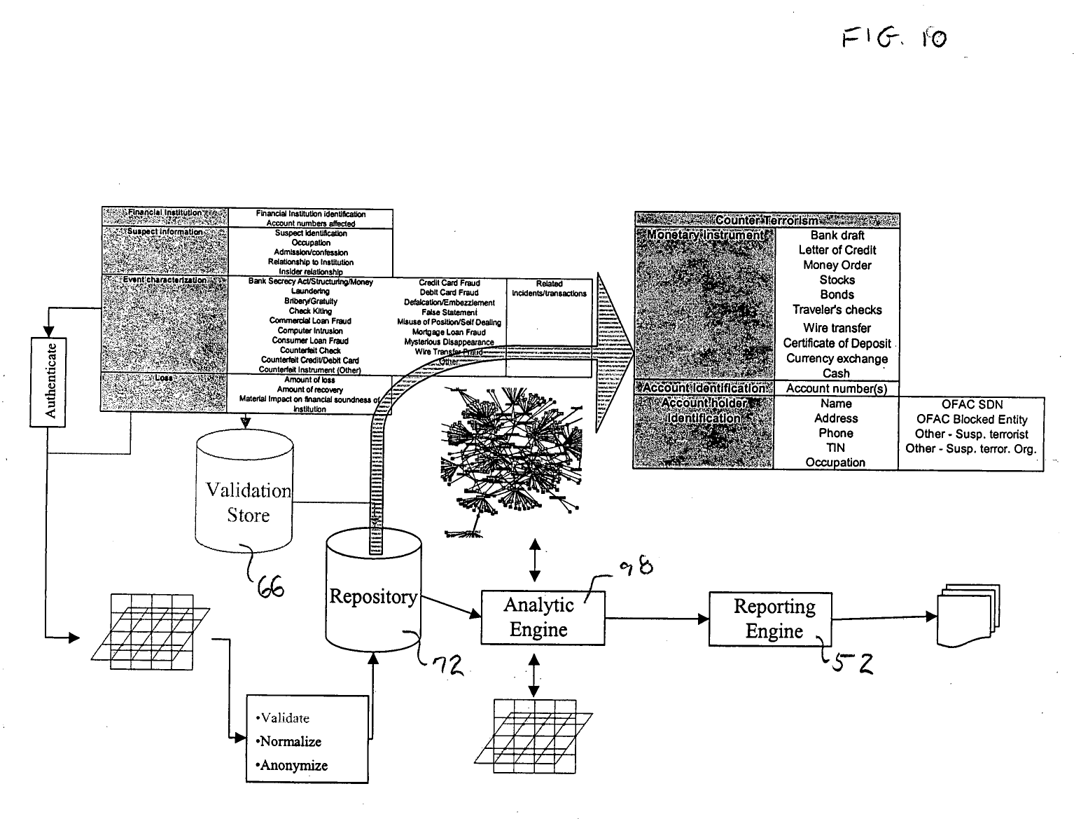

FIG. 10 illustrates how the functionality of the system of FIG. 7 may be extended using, for example, a problem set represented by SAR data. This data relates to anti-money laundering and counter-terrorist financing activities, as reported to FINCEN (Financial Crimes Enforcement Network). Anti-money laundering and counter-terrorist financing are loss activity components covered by Basel II and operational risk management for banks.

To achieve crime control and national security objectives, the SAR reporting system should be capable of accepting very large streams of data and operating on that data so that law enforcement agencies receive a point report that proscribed activity has been observed and information that can be used to identify and correlate data from distributed events to surface broader forensic information and non-obvious relationships, as well as information that can be used to identify hot spots of system weakness that require attention.

The OR Model component of the system can be used by an analytic engine 98 to assess the sufficiency of the data set captured by current SAR reporting forms and reveal gaps that should be filled. The analytic capabilities of the system can process SAR input data and provide information on how different banks are experiencing suspicious activity in this area. The system can provide typology information as well as information on industry hot spots. The system can also process the entire set of SAR information reported to FINCEN and provide reports based on advanced analytic operators.

The methods in this disclosure are preferably implemented in software, with the software being stored on any suitable storage medium consistent with the hardware being used.

While the present invention has been described in connection with preferred embodiments thereof, those of ordinary skill in the art will recognize that many modifications and variations are possible. The present invention is intended to be limited only by the following claims and not by the foregoing description which is intended to set forth the presently preferred embodiment.

1. A method of dynamically creating a database, comprising:
receiving event data from a plurality of independent agents input according to a common taxonomy that exposes the event in its molecular terms; and
storing the event data.

2. The method of claim 1 wherein said receiving data includes receiving causal factors driving the event and mitigating factors related to the event, said causal factors and mitigating factors are weighted.

3. The method of claim 1 additionally comprising authenticating the agent from which the event data is received.

4. The method of claim 1 additionally comprising validating the event data.

5. The method of claim 1 additionally comprising normalizing the event data.

6. The method of claim 1 additionally comprising anonymizing the event data.

7. The method of claim 1 additionally comprising scaling the event data.

8. The method of claim 1 additionally comprising adding synthetic event data to the database.

9. The method of claim 8 wherein said synthetic event data is generated by one of a test bed or a subject matter expert.

10. A method of dynamically creating a pooled knowledge base, comprising:
receiving event data from a plurality of independent agents;
decomposing the event data into its molecular terms including at least one weighted causal factor; and
forwarding the event data for storage.

11. The method of claim 10 additionally comprising authenticating the agent from which the event data is received.

12. The method of claim 10 additionally comprising validating the event data.

13. The method of claim 10 additionally comprising normalizing the event data.

14. The method of claim 10 additionally comprising anonymizing the event data.

15. The method of claim 10 additionally comprising scaling the event data.

16. The method of claim 10 additionally comprising adding synthetic event data to the knowledge base.

17. The method of claim 16 wherein said synthetic event data is generated by one of a test bed or a subject matter expert.

18. A method of dynamically generating an aggregate database, comprising:
collecting event data including weighted casual factors and weighted mitigating factors;
normalizing the event data;
anonymizing the event data; and
storing the event data in a repository.

19. The method of claim 18 additionally comprising validating the event data.

20. The method of claim 18 additionally comprising adding synthetic data to the event data in the repository.

21. The method of claim 20 wherein said synthetic data is generated by one of a test bed and a subject matter expert.

22. A computer readable medium encoded with a computer program which, when executed, performs the method comprising;
receiving event data from a plurality of independent agents input according to a common taxonomy that exposes the event in its molecular terms; and
storing the event data.

23. A computer readable medium encoded with a computer program which, when executed, performs the method comprising;
receiving event data from a plurality of independent agents;
decomposing the event data into its molecular terms including at least one weighted causal factor; and
forwarding the event data for storage.

24. A computer readable medium encoded with a computer program which, when executed, performs the method comprising;
collecting event data including weighted casual factors and weighted mitigating factors;
normalizing the event data;
anonymizing the event data; and
storing the event data in a repository.

25. A method of operating on a pooled knowledge base comprised of event data and its molecular components to produce one of a risk report, optimization report, resource allocation report, failure prediction report, root cause report, and what if report.

26. A method of operating on a pooled knowledge base comprised of loss event data and its molecular components to produce one of an aggregate loss distribution, a point loss benchmark, an alert, a report and a simulated capital charge.
